(19) United States
(12) Patent Application Publication
(10) Pub. No.: US 2013/0032580 A1
(43) Pub. Date: Feb. 7, 2013

(54) OPTICAL PATH STRUCTURE OF LASER PROCESSING MACHINE

(71) Applicants: Shigeru Yokoi, Tokyo (JP); Yasuhiko Iwai, Aichi (JP); Hajime Osanai, Aichi (JP); Kenji Saruta, Aichi (JP)

(72) Inventors: Shigeru Yokoi, Tokyo (JP); Yasuhiko Iwai, Aichi (JP); Hajime Osanai, Aichi (JP); Kenji Saruta, Aichi (JP)

(73) Assignee: MITSUBISHI ELECTRIC CORPORATION, Chiyoda-ku, Tokyo (JP)

(21) Appl. No.: 13/639,775

(22) PCT Filed: Nov. 11, 2011
(86) PCT No.: PCT/JP2011/076093

§ 371 Date: Oct. 5, 2012

(30) Foreign Application Priority Data
Nov. 29, 2010 (JP) 2010-265274

(51) Int. Cl. B23K 26/00

(52) U.S. Cl. 219/121.6

(57) ABSTRACT

An optical path structure of a laser processing machine that irradiates a laser beam from a processing head to a workpiece to perform laser processing, includes: a casing that has an opening, a light leading unit that includes a bend block including a bend mirror which deflects a laser beam traveling within the casing toward a side of the opening and an optical path tube which protrudes from the bend block toward the side of the opening for leading the laser beam to the processing head, a sealing member that is arranged at an edge part of the opening, a moving member that is abutting against the sealing member, that slides with respect to the sealing member, and that is fixed to the light leading unit, and a drive unit that integrally moves the moving member and the light leading unit in a longitudinal direction of the moving member.

### FIELD

The present invention relates to a laser processing machine, and more particularly to an optical path structure of an optical-scanning laser processing machine in which an optical path is moved.

### BACKGROUND

In a laser processing machine that does not use any transmission member such as an optical fiber represented by a carbon-dioxide gas-laser processing machine, particularly in an optical-scanning laser processing machine that moves an optical element (such as a bend mirror or a processing lens) for processing, an optical path is moved. Accordingly, this type of laser processing machine includes a bellows or a telescopic mechanism at a moving part for protecting the moving part of the optical path (see, for example, Patent Literatures 1 and 3).

When the bellows or the telescopic mechanism is applied to a high-output carbon-dioxide gas-laser processing machine, it is required that the bellows or the telescopic mechanism can withstand high-speed repeated moving, has a small extension allowance, has a high degree of hermetical sealing, exhibits no dusting characteristics, does not perform breathing (that is, when an optical path is moved, air does not enter or exit), is resistant to external dust, and does not cause burning.

Progress of speeding up of laser processing machines is significant, and currently there are devices having a feed-forward speed exceeding 100 m/min. Therefore, durability against high-speed repeated moving is important.

A small extension allowance is required to make a device compact and reduce the entire optical path length for improving processing stability.

Generally, clean dry air or nitrogen is purged in an optical path to maintain the quality of a transmitted laser beam to be constant, the inside of the optical path is made to be in a pressurized state with a pressure being higher than open air (atmosphere) by about 0.5 kiloPascal (about 50 mmAq) to enhance the degree of cleanness within the optical path, and also dust is prevented from entering from outside. The degree of hermetical sealing of an optical path structure is thus required to be high.

Furthermore, it is required to prevent that external dust as a matter evaporated and scattered by thermal processing such as fume or sputter generated by laser processing does not enter the optical path.

While it is obvious that the optical path structure itself does not have dusting characteristics, when breathing occurs, external dust is taken in. Therefore, a structure in which breathing does not occur is required to reduce a purge amount.

It is required to avoid a state such that a laser beam is irradiated inside and outside an optical path in a case of a laser beam within the optical path being diffused or shifted or because of secondary reflection light from a high-reflection object to be processed such as aluminum arranged near a laser processing point, and consequently burning occurs.

With respect to an optical path structure that moves an optical path without using a bellows or a telescopic mechanism, Patent Literature 4 discloses a device constituted by an endless belt that closes an opening of a duct and operates integrally with a moving base.

Patent Literature 5 discloses a configuration in which a seal is provided between a moving endless belt and a dust-proof cover.

Patent Literatures 6 and 7 disclose a configuration in which longitudinal-direction ends of a belt are fixed along an opening part and a moving unit partially releases closure of the belt of the opening part along with its movement.

### CITATION LIST

### Patent Literatures

Patent Literature 1: Japanese Patent No. 3353059

Patent Literature 2: Japanese Patent No. 3633117

Patent Literature 3: Japanese Patent No. 4187482

Patent Literature 4: Japanese Patent Application Laid-open No. S63-63595

Patent Literature 5: Japanese Patent Application Laid-open No. H05-77076

Patent Literature 6: Japanese Patent Application Laid-open No. 2010-188424

Patent Literature 7: Japanese Patent No. 4527415

### SUMMARY

### Technical Problem

Regarding applications of a bellows or a telescopic mechanism to an optical path structure, the bellows is more commonly used and the telescopic mechanism is practically merely used for a low-output medical instrument (such as a laser knife) used in a clean environment in a case of a carbon-dioxide gas laser. Generally, while the bellows is manufactured by a synthetic fiber or a plastic, a resin itself has dusting characteristics and its degree of hermetical sealing is low. While improvements of bonding and adhering several layers to each other to enhance the degree of hermetical sealing and of using fibers with high airtightness have been made, a disadvantage of increasing an extension allowance occurs and there are troubles such that external dust is sucked in by breathing caused by extension and contraction of the bellows particularly during a high-speed operation and the bellows is broken. Therefore, an influence of a volume variation has to be suppressed by, for example, providing a counter bellows or a buffer tank.

Furthermore, while measures such as providing a metallic reflection plate within the bellows, using a flame retardant material, and incorporating a burning detecting sensor are taken to prevent a burning accident, this leads to a problem that the structure becomes complicated and expensive.

Regarding the optical path structure that moves an optical path without using a bellows or a telescopic mechanism, Patent Literature 4 does not disclose any sealing structure. Therefore, the invention disclosed in Patent Literature 4 is not a practical device that can maintain airtightness of the inside of the optical path.

According to the invention disclosed in Patent Literature 5, an outer edge part of a belt is sealed; however, dust is easily adhered to outside of the belt. Because the dust adhered to outside of the belt wears or deteriorates a seal, the invention disclosed in Patent Literature 5 has a problem in view of a hermetical sealing property, airtightness, and lifetime. Furthermore, it is difficult to provide a dust-proof cover at further outside and thus the configuration of driving the belt by a roller that supports and guides the belt is not a configuration in which a high-speed operation can be performed repeatedly.

According to the inventions disclosed in Patent Literatures 6 and 7, it is difficult to maintain airtightness of particularly the opening part and transverse direction ends of the belt lifted by the moving unit and a magnet adsorbing the belt also attracts ferromagnetic dust such as iron and thus the inventions are not practical.

The present invention has been achieved in view of the above problems, and an object of the present invention is to provide an optical path structure of a laser processing machine in which moving of an optical path can be performed repeatedly at a high speed, there is almost no extension allowance, high airtightness is provided, breathing does not occur, external dust is prevented from entering an optical path, and occurrence of burning is prevented.

### Solution to Problem

In order to solve the above problem and in order to attain the above object, in an optical path structure of a laser processing machine that irradiates a laser beam from a processing head to an object to be processed to perform laser processing, the optical path structure of the present invention, includes: a casing that is formed in an elongated box shape and has an opening at one of longitudinal surfaces; a light leading unit that includes a bend block including a bend mirror which deflects a laser beam traveling within the casing in a longitudinal direction of the casing toward a side of the opening and is arranged within the casing so as to be movable in a longitudinal direction of the casing, that includes an optical path tube that is provided so as to protrude from the bend block toward the side of the opening and covers an optical path of the laser beam deflected by the bend mirror toward the side of the opening, and that leads the laser beam having passed through the optical path tube to the processing head; a sealing member that is constituted by an elastic body and arranged at an edge part of the opening; a moving member that is formed in a band shape while abutting against the sealing member outside the casing to close the opening, that slides with respect to the sealing member to be movable in a longitudinal direction while closing the opening, and that is fixed to the light leading unit; and a drive unit that integrally moves the moving member and the light leading unit in a longitudinal direction of the moving member.

### Advantageous Effects of Invention

According to the present invention, moving of an optical path can be performed repeatedly at a high speed, there is no extension allowance, high airtightness is provided, breathing does not occur, external dust can be prevented from entering an optical path, and occurrence of burning can be prevented.

### BRIEF DESCRIPTION OF DRAWINGS

FIG. 1 depicts a configuration of an optical path structure of a laser processing machine according to a first embodiment of the present invention.

FIG. 2 is a plan view of the optical path structure of a laser processing machine.

FIG. 3 is a cross-sectional view of a longitudinal-direction edge part of an opening.

FIG. 4 depicts a state where a guide roller abuts against a moving member.

FIG. 5 depicts a configuration of an optical path structure of a laser processing machine according to a second embodiment of the present invention.

FIG. 6 depicts a configuration of an optical path structure of a laser processing machine according to a third embodiment of the present invention.

FIG. 7 depicts a state where a scraper and a roller abut against a moving member.

FIG. 8 is a cross-sectional view of a longitudinal-direction edge part of an opening in an optical path structure of a laser processing machine according to a fourth embodiment of the present invention.

### DESCRIPTION OF EMBODIMENTS

Exemplary embodiments of an optical path structure of a laser processing machine according to the present invention will be explained below in detail with reference to the accompanying drawings. The present invention is not limited to the embodiments.

### First Embodiment

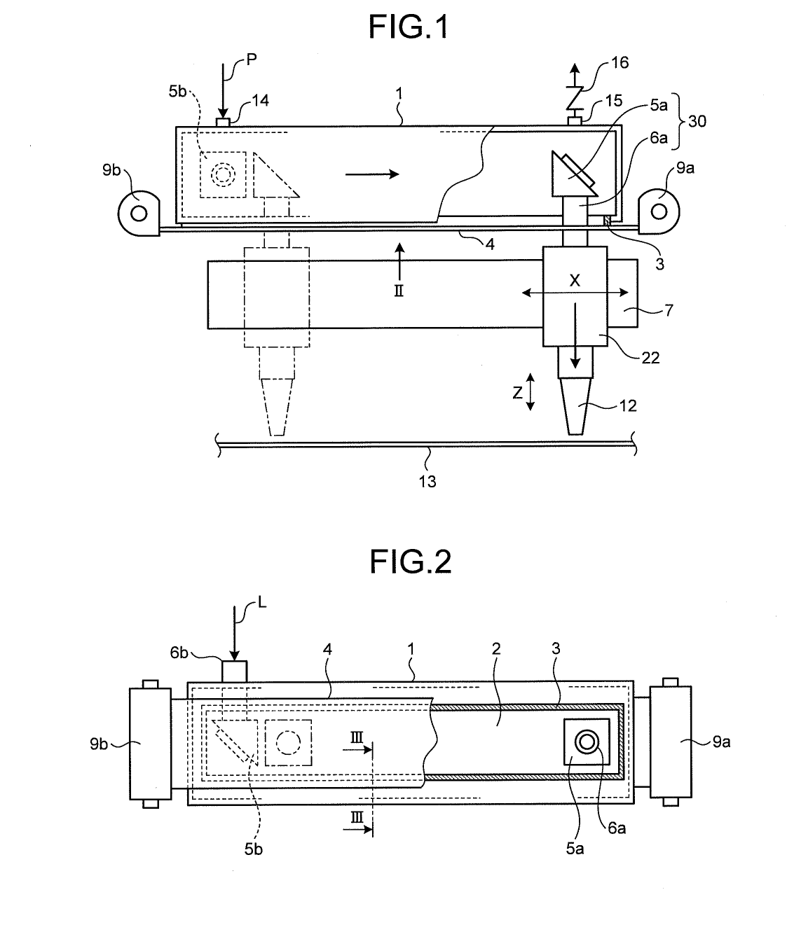

FIG. 1 depicts a configuration of an optical path structure of a laser processing machine according to a first embodiment of the present invention. FIG. 2 is a plan view of the optical path structure of a laser processing machine and an arrow II of FIG. 1 is regarded as a viewing direction. A casing 1 is constituted by a metal plate or the like so as to cover the entire optical path and is hermetically sealed. An opening 2 is provided at a bottom surface of the casing 1 along a moving part of an optical path. A sealing member 3 is formed by a rubber material or the like having elasticity and provided at a peripheral inner-edge part of the opening 2. A moving member 4 is formed by a metallic material or the like into a band shape, abuts against the sealing member 3 so as to close the opening 2, and slides to move. A bend block 5a includes a bend mirror that deflects a laser beam L and is provided within the casing 1. An optical path tube 6a is mounted to the bend block 5a, covers an optical path of the laser beam L deflected by the bend mirror toward an opening side, and penetrates the moving member 4 to protrude outside the casing 1. The moving member 4 is fixed and coupled to the optical path tube 6a. In the present embodiment, the bend block 5a and the optical path tube 6a constitute a light leading unit 30 that leads the laser beam L to a processing head 12. A bend block 5b is a fixed bend block arranged within the casing 1 and is connected to an optical path tube 6b. A Z-axis unit 22 includes the processing head 12 and is connected to the optical path tube 6a. The Z-axis unit 22 has a function of operating the processing head 12 in a Z-axis direction shown in FIG. 1 so as to be focused on a workpiece 13, which is an object to be processed. The Z-axis unit 22 is also constituted so as to be driven to move by a drive unit 7 in an X-axis direction shown in FIG. 1 with the bend block 5a, the optical path tube 6a, and the processing head 12. While a configuration that the drive unit 7 is formed in a belt shape fixed to the Z-axis unit 22 is described in the present embodiment, as long as the Z-axis unit 22, the optical path tube 6a, the processing head 12, and the bend block 5a can be integrally moved in parallel, any known configuration can be applied. For example, it is possible that a pinion and a motor for driving the pinion are provided in the Z-axis unit 22 so that the pinion is moved along a rack. A configuration that a linear motor is provided in the Z-axis unit 22 for moving the Z-axis unit 22 is also possible.

A purge-gas inlet 14, a purge-gas outlet 15, and a check valve 16 are provided in the casing 1.

An operation of the optical path structure of a laser processing machine is explained. The laser beam L output from a laser oscillator (not shown) is introduced in the casing 1 via the optical path tube 6b, deflected by the bend block 5b in the X-axis direction, and led to the bend block 5a.

In the bend block 5a, the laser beam L is deflected in the Z-axis direction, transmitted via the optical path tube 6a and the Z-axis unit 22 to the processing head 12, and then changed into a collected laser beam by a processing lens provided in the processing head 12. The collected laser beam is irradiated on the workpiece 13.

When the Z-axis unit 22 is driven to move by the drive unit 7, the processing head 12, the optical path tube 6a, and the bend block 5a are also moved in the X-axis direction correspondingly. Similarly, the moving member 4 fixed and coupled to the optical path tube 6a is also moved in the X-axis direction. At this time, because the moving member 4 slides while abutting against the sealing member 3, airtightness within the casing 1 that protects the optical path of the laser beam L is maintained even at the time of laser processing while moving the processing head 12.

Clean dry air or nitrogen is introduced as purge gas P from the purge-gas inlet 14 in the casing 1. The purge gas P introduced in the casing 1 circulates within the casing 1 and then discharged from the purge-gas outlet 15 via the check valve 16 to the atmosphere.

Because the purge gas P slightly leaks at a part where the moving member 4 abuts against or slides on the sealing member 3 when the device stops or operates (that is, constantly), a flow rate and a pressure of the purge gas P are adjusted so that a barometric pressure within the casing 1 is maintained to be slightly higher than an atmospheric pressure (by about 0.5 kiloPascal). As in a device using a bellows, an inlet pressure of the purge gas P is 0.1 to 0.3 kiloPascal and the flow rate is about 50 to 100 NL/min, and thus the barometric pressure within the casing 1 can be maintained to be slightly higher than the atmospheric pressure.

Furthermore, during operations, dust is easily adhered to a part on a side of the casing 1 of the moving member 4 and outside of the sealing member 3 (a part exposed to the outer air) and the dust adhered to this part may enter the casing 1 via the sealing member 3. To prevent this state, a dust-proof cover can be provided at the both ends of the casing 1.

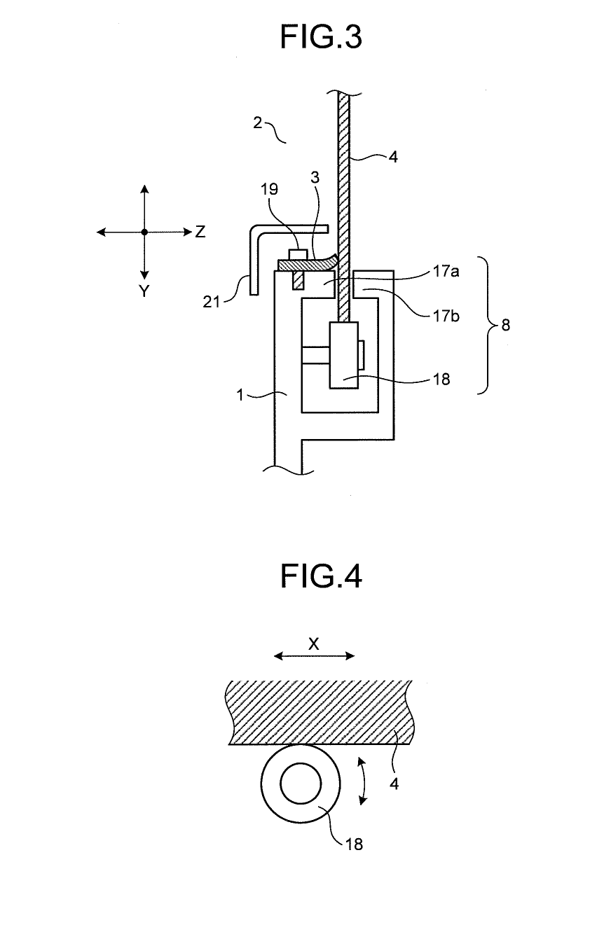

FIG. 3 is a cross-sectional view of a longitudinal-direction edge part of the opening 2 and depicts a cross-section along III-III of FIG. 2. Rails 17a and 17b are provided so as to sandwich the moving member 4 near the edge part of the opening 2 of the casing 1. Although not shown, the rails 17a and 17b and a guide roller 18 are also provided on the opposite side of the moving member 4 in a transverse direction and these constitute a guide unit 8 of the moving member 4. FIG. 4 depicts a state where the guide roller 18 abuts against the moving member 4. As shown in FIG. 4, the guide roller 18 is provided so as to abut against a transverse-direction end surface of the moving member 4.

A screw 19 shown in FIG. 3 fixes the sealing member 3 against or on which the moving member 4 abuts or slides to the edge part of the opening 2 of the casing 1. An urethane tape or a polytetrafluoroethylene (fluoro-rubber) tape, or a tape manufactured by using a material having a self-lubricating property such as ultrahigh-molecular-weight polyethylene is preferably applied to parts of the rails 17a and 17b guiding the moving member 4 for smoothly guiding the moving member 4.

A stainless bearing is used for the guide roller 18 and the guide rollers 18 is provided in plural in a moving direction of the moving member 4. According to the guide unit 8, the rails 17a and 17b regulates and guide a moving range in a Y-axis direction (a width direction) perpendicular to the X-axis, of a movement direction of the moving member 4 and the guide roller 18 regulates and guides the moving range in a Z-axis direction (a thickness direction) of the movement direction of the moving member 4. The guide unit 8 more reliably maintains that the moving member 4 abuts against or slides on the sealing member 3.

Furthermore, because a part that may be burnt by the laser beam L is very limited unlike a bellows, almost no burning occurs. By providing a metallic beam-blocking plate 21 along the sealing member 3, occurrence of burning can be prevented more reliably.

A distal end of the sealing member 3 (a part of the sealing member 3 abutting against the moving member 4) is formed in a lip shape. By forming the distal end of the sealing member 3 in a lip shape, elasticity of the sealing member 3 can be increased and sliding resistance can be reduced. Furthermore, by forming the distal end of the sealing member 3 in a lip shape, an airtightness-maintaining property can be enhanced. As a material for the sealing member 3, various types of rubber such as natural rubber, chloroprene rubber, fluoro-rubber, and urethane rubber can be applied. Because urethane rubber is inexpensive, easily available, has excellent mechanical characteristics such as high wear-resistance as well as reduced sliding resistance, and can be molded while its hardness is adjusted to a desired level, urethane rubber is appropriate for the material for the sealing member 3.

The moving member 4 is formed by a stainless steel band having a thickness of 0.05 to 0.35 millimeter and a spring property. Preferably, the moving member 4 also has a spring property to enhance its airtightness. When the moving member 4 is too thin, it is easily broken, and when the moving member 4 is too thick, its flexibility is poor and thus the airtightness is reduced and it is difficult to accommodate the moving member 4 compactly. Accordingly, the thickness in the rage mentioned above is preferable. The present inventors performed various tests while changing the thickness of a stainless steel band used as the moving member 4. As a result, it was confirmed that when stainless steel bands having a spring property and a thickness of 0.1 millimeter, 0.2 millimeter, and 0.3 millimeter, respectively, were used as the moving member 4, problems were not found in various characteristics such as airtightness, durability, and flex resistance of the moving member 4. When a stainless steel band having a thickness of 0.4 millimeter was used, the flexibility of the moving member 4 is low and thus it was inappropriate for the moving member 4. Furthermore, a stainless steel band having a thickness of less than 0.05 millimeter lacked strength and thus it was inappropriate for the moving member 4.

The moving member 4 formed by a thin material having a thickness of about 0.05 millimeter is appropriate for an optical path structure that is compact and has a reduced laser output and a small stroke. The moving member 4 formed by a thick material having a thickness to 0.35 millimeter is appropriate for a large optical path structure with a large stroke. By using the stainless steel band as the material for the moving member 4, a rust-preventing property and the flex resistance can be enhanced. Furthermore, the moving member 4 having a smooth surface can be realized.

As shown in FIGS. 1 and 2, winding/unwinding devices 9a and 9b are provided at the both ends of the casing 1 in the moving direction of the moving member 4. When the moving member 4 is moved in a right direction of FIGS. 1 and 2, the winding/unwinding device 9a winds the moving member 4 and the winding/unwinding device 9b unwinds the moving member 4. When the moving member 4 is moved in a left direction of FIGS. 1 and 2, the winding/unwinding device 9a unwinds the moving member 4 and the winding/unwinding device 9b winds the moving member 4.

While the winding/unwinding devices 9a and 9b can be constituted by using a spiral spring, a tension at the time of winding or unwinding can be controlled by using a servomotor or the winding/unwinding devices 9a and 9b can cooperate with the drive unit 7 that serves as a drive device of the moving member 4 so as to be operated in synchronization with the drive unit 7.

According to the present embodiment, because a member that extends and contracts such as a bellows is not used, an extension allowance is not required. Therefore, according to a laser processing machine having the optical path structure of the present embodiment, an optical path is reduced and stable laser processing is possible. The device can be also designed to be compact. Furthermore, high airtightness can be maintained without any breathing phenomenon in the optical path associated with an operation of the optical path occurring. Because dust does not enter a casing from outside, the inside of the casing can be always kept clean. Because a part contacting the laser beam L is constituted by a metallic material, occurrence of burning can be prevented. That is, a high-performance and safe optical path structure can be provided easily and inexpensively.

Furthermore, because a guide unit of a moving member reliably ensures moving of the moving member in a correct moving direction, a highly-reliable optical path structure in which airtightness and a property of preventing dust from entering are stable can be realized.

By using a winding/unwinding device, it is ensured that the both ends of the moving member are reliably accommodated in the device, and the optical path structure can be made compact.

### Second Embodiment

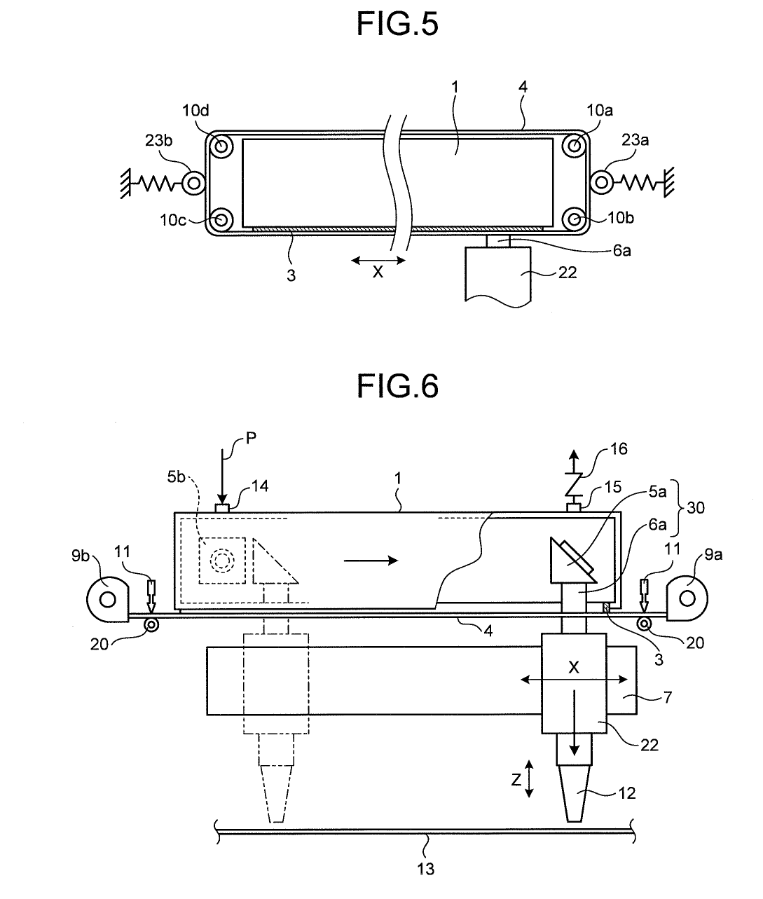

FIG. 5 depicts a configuration of an optical path structure of a laser processing machine according to a second embodiment of the present invention. The present embodiment is different from the first embodiment in that the both ends of the moving member 4 are connected and coupled to each other and thus the moving member 4 is endless, and the moving member 4 is supported by support rollers 10a to 10d outside the casing 1 and moved with the optical path tube 6a. Configurations of the casing 1, the Z-axis unit 22 and the like are identical to those in the first embodiment.

A surface of each of the support rollers 10a to 10d on which the moving member 4 rolls is a curved surface with its central part being convex and the support rollers 10a to 10d are formed in a center-bulging drum shape (a crown shape) as a whole. Because the support rollers 10a to 10d are formed in a drum shape, the support rollers 10a to 10d correct so that the moving member 4 is not moved in a direction perpendicular to the moving direction. The support rollers 10a to 10d can thus stably support the moving member 4 and guide moving of the moving member 4 in the moving direction. The support rollers 10a to 10d also have a large curvature sufficient for the moving member 4 not to be plastically deformed. When the support rollers 10a to 10d are light, their rotating speed is easily changed as the speed follows a change in the moving speed of the moving member 4 and thus the support rollers 10a to 10d have excellent slip resistance. Furthermore, because dynamical friction hardly occurs between the support rollers 10a to 10d and the moving member 4, wear-resistance is also improved. Further, when wear-resistance coating (such as hard chromium plating) is applied to the rolling surface of each of the support rollers 10a to 10d and the rolling surface is ground, excellent wear-resistance is provided.

By providing tension rollers 23a and 23b at appropriate positions, even when the moving member 4 is repeatedly moved at a high speed, the moving member 4 hardly slips against the support rollers 10a to 10d. Furthermore, it is possible to constitute such that at least some of the support rollers 10a to 10d are elastically supported so as to be movable to some extent in the moving direction of the moving member 4 (the X-axis direction) and in the direction perpendicular to the moving direction (the Y-axis direction).

Although not shown, in order to guide the moving member 4, the same configuration as that in the guide unit 8 shown in FIG. 3 or a simplified configuration can be provided at a part where the moving member 4 is moved in the X-axis direction on a side of the casing 1 that the opening 2 (not shown in FIG. 5) and the sealing member 3 are not present.

According to the present embodiment, the moving member 4 is easily moved repeatedly at a high speed and even when a moving stroke of an optical path is long (for example, equal to or longer than 3 meters), the optical path structure can be made compact. Furthermore, by elastically supporting the support rollers 10a to 10d so as to be movable in the moving direction of the moving member 4 and providing the tension rollers 23a and 23b at appropriate positions, it is possible to prevent the moving member 4 from being bent in the moving direction during an accelerating/decelerating operation of the moving member 4, resulting in an operation failure. It is also possible to prevent the support rollers 10a to 10d from slipping against the moving member 4 and the support rollers 10a to 10d and the moving member 4 from being worn and broken.

### Third Embodiment

FIG. 6 depicts a configuration of an optical path structure of a laser processing machine according to a third embodiment of the present invention. The third embodiment is different from the first embodiment in that a scraper 11 and a roller 20 are provided at the both ends of the casing 1 in the movement direction of the moving member 4.

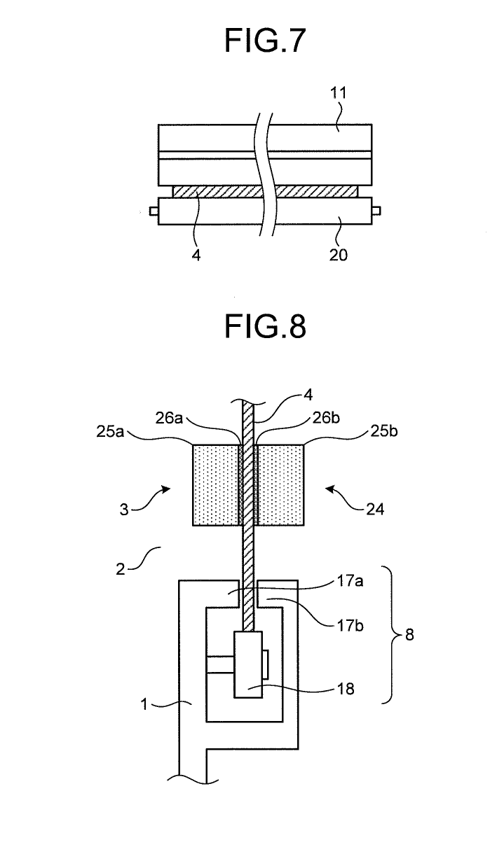

The scraper 11 is provided so as to abut against a side (inside) of the moving member 4 abutting against or sliding on the sealing member 3. The roller 20 is provided on an opposite side (outside) of a part where the scraper 11 abuts against the moving member 4. FIG. 7 depicts a state where the scraper 11 and the roller 20 abut against the moving member 4. As shown in FIG. 7, the scraper 11 and the roller 20 abut against the moving member 4 over its entire width.

A cross-section of the scraper 11 is formed in a shape having a lip (an arrow shape) like a wiper of an automobile and a lip part of the scraper 11 abuts against or slides on the moving member 4 according to moving of the moving member 4. Dust adhered to the inside of the moving member 4 is thus removed by the scraper 11. Similarly, dust adhered to outside of the moving member 4 is removed by the roller 20.

While a configuration of providing a pair of the scraper 11 and the roller 20 at each of the both ends of the casing 1 has been explained as an example, it is also possible to provide plural pairs of the scraper 11 and the roller 20.

According to the present embodiment, because dust adhered particularly to the inside of the moving member 4 can be removed by the scraper 11, the dust adhered to the moving member 4 can be prevented from being taken in the casing 1, the airtightness and cleanliness within the casing 1 can be ensured, and a long lifetime of the sealing member 3 can be realized.

### Fourth Embodiment

FIG. 8 is a cross-sectional view of a longitudinal-direction edge part of the opening 2 in an optical path structure of a laser processing machine according to a fourth embodiment of the present invention. In FIG. 8, the left side is the inside of the casing 1 and the right side is the outside of the casing 1. According to the present embodiment, the sealing member 3 is constituted by a spongy elastic body 25a and a resin tape 26a applied to the spongy elastic body 25a. While a support structure (a mounting structure) of the sealing member 3 is omitted from FIG. 8 for simplifying explanations, the sealing member 3 is mounted to the casing 1 at the peripheral inner-edge part of the opening 2 without any space.

The sealing member 3 is arranged so that the resin tape 25a abuts against the moving member 4 with the spongy elastic body 25a having an appropriate contraction allowance.

A pressing member 24 constituted by a spongy elastic body 25b and a resin tape 26b applied to the spongy elastic body 25b is arranged on a side of the moving member 4 opposite the side that the sealing member 3 is provided. The pressing member 24 is arranged so that the resin tape 25b abuts against the moving member 4 with the spongy elastic body 25b having an appropriate contraction allowance.

The guide unit 8 constituted by the rails 17a and 17b and the guide roller 18 is the same as in the first embodiment.

The sealing member 3 and the pressing member 24 nip the moving member 4 at fixed elasticity. When the moving member 4 is moved, the sealing member 3 mounted to the peripheral inner-edge part of the opening 2 maintains the airtightness within the casing 1. The pressing member 24 ensures that the moving member 4 abuts against the resin tape 26a of the sealing member 3.

A latex sponge, a chloroprene-rubber-coated latex sponge, a chloroprene sponge, and a silicon sponge can be applied to the spongy elastic bodies 25a and 25b. Because the chloroprene-rubber-coated latex sponge has such a characteristic that chloroprene rubber with high durability is coated on a latex sponge, which is inexpensive and has excellent elasticity but has reduced durability, the chloroprene-rubber-coated latex sponge is appropriate for the spongy elastic bodies 25a and 25b.

Ultrahigh-molecular-weight polyethylene, polytetrafluoroethylene, and urethane can be applied to a material for the resin tapes 26a and 26b. Because the ultrahigh-molecular-weight polyethylene is commercially available, it is easily accessible, has a small friction coefficient because of a high self-lubricating property, and has a high mechanical strength and wear-resistance. Therefore, ultrahigh-molecular-weight polyethylene is appropriate for the material for the resin tapes 26a and 26b. As an example, there was a test result such that even when a stainless belt was used for the moving member 4 and the moving member 4 was made to abut or slide repeatedly at a moving speed of 100 m/min for about 100 hours, degradation and wear were hardly found in the moving member 4.

According to the present embodiment, because a sealing member includes a spongy elastic body arranged on inside of an opening, abutment of the sealing member against a moving member is ensured. Furthermore, because the sealing member also includes a resin tape, slide-friction resistance with respect to the moving member is reduced and the airtightness is maintained. Because a pressing member arranged on the outside is constituted by the spongy elastic body and the resin tape, it is possible to ensure that the moving member abuts against the resin tape of the sealing member on the inside while the slide-friction resistance with respect to the moving member is reduced.

By constituting the spongy elastic body by a chloroprene-rubber-coated latex sponge, the spongy elastic body maintains elasticity for a long period of time without any degradation. Therefore, it is possible to ensure that the moving member abuts against or slides on the resin tape. Because the resin tape made of an ultrahigh-molecular-weight polyethylene resin has small sliding resistance because of a small friction coefficient, the airtightness and hermetical sealing property of a part of the resin tape against or on which the moving member abuts or slides can be maintained for a long period of time.

In the respective embodiments described above, a configuration that the opening 2 is provided on the bottom surface of the casing 1 has been explained as an example; however, the opening 2 can be provided on a side surface or a top surface of the casing 1. Furthermore, while a configuration that the moving member 4 is fixed to the optical path tube 6 has been explained as an example, the bend block 5 is caused to protrude from the opening 2 or the moving member 4 is caused to enter the casing 1, so that the moving member 4 can be fixed to the bend block 5.

### INDUSTRIAL APPLICABILITY

As described above, the optical path structure of a laser processing machine according to the present invention is useful in characteristics such that moving of an optical path can be performed repeatedly at a high speed, there is no extension allowance, high airtightness is provided, breathing does not occur, external dust is prevented from entering an optical path, and occurrence of burning is prevented, and the optical path structure is particularly suitable for a large optical-scanning laser processing machine having a large movement amount in an optical path.

### REFERENCE SIGNS LIST

1 casing
2 opening
3 sealing member
4 moving member
5a, 5b bend block
6a, 6b optical path tube
7 drive unit
8 guide unit
9a, 9b winding/unwinding device
10a, 10b, 10c, 10d support roller
11 scraper
12 processing head
13 workpiece
14 purge-gas inlet
15 purge-gas outlet
16 check valve
17a, 17b rail
18 guide roller
19 screw
20 roller
21 beam-blocking plate
22 Z-axis unit
23a, 23b tension roller
24 pressing member
25a, 25b spongy elastic body
26a, 26b resin tape
30 light leading unit
L laser beam
P purge gas

1. An optical path structure of a laser processing machine that irradiates a laser beam from a processing head to an object to be processed to perform laser processing, the optical path structure comprising:
a casing that is formed in an elongated box shape and has an opening at one of longitudinal surfaces;
a light leading unit that includes a bend block including a bend mirror which deflects a laser beam traveling within the casing in a longitudinal direction of the casing toward a side of the opening and is arranged within the casing so as to be movable in a longitudinal direction of the casing, that includes an optical path tube that is provided so as to protrude from the bend block toward the side of the opening and covers an optical path of the laser beam deflected by the bend mirror toward the side of the opening, and that leads the laser beam having passed through the optical path tube to the processing head;
a sealing member that is constituted by an elastic body and arranged at an edge part of the opening;
a moving member that is formed in a band shape while abutting against the sealing member outside the casing to close the opening, that slides with respect to the sealing member to be movable in a longitudinal direction while closing the opening, and that is fixed to the light leading unit; and
a drive unit that integrally moves the moving member and the light leading unit in a longitudinal direction of the moving member, wherein the casing includes a guide unit that regulates moving of the moving member in a width direction and a thickness direction.

2. (canceled)

3. The optical path structure of a laser processing machine according to claim 1, further comprising a winding/unwinding device that winds or unwinds the moving member near each of longitudinal direction ends of the casing.

4. The optical path structure of a laser processing machine according to claim 1, wherein the moving member is formed in an endless shape with both ends being bonded to each other, arranged so as to surround the casing, and moving of the moving member is guided by a support roller arranged around the casing.

5. The optical path structure of a laser processing machine according to claim 4, wherein the support roller is elastically arranged so as to be movable in a moving direction of the moving member.

6. The optical path structure of a laser processing machine according to claim 4, further comprising a tension roller that keeps a tension of the moving member constant.

7. The optical path structure of a laser processing machine according to claim 4, wherein the support roller is formed in a drum shape.

8. The optical path structure of a laser processing machine according to claim 1, further comprising a scraper that abuts against a surface of the moving member abutting against the sealing member.

9. The optical path structure of a laser processing machine according to claim 1, wherein
the sealing member is made of urethane rubber, a part of the sealing member abutting against the moving member is formed in a lip shape, and
the moving member is a stainless steel band.

10. The optical path structure of a laser processing machine according to claim 1, wherein
the sealing member is constituted by a spongy elastic body mounted to an edge part of the opening and a resin tape applied to the spongy elastic body, and
a pressing member constituted by applying a resin tape to a spongy elastic body is arranged so as to oppose the sealing member with the moving member being interposed therebetween.

11. The optical path structure of a laser processing machine according to claim 10, wherein
the spongy elastic body is a chloroprene-rubber-coated latex sponge, and
the resin tape is constituted by an ultrahigh-molecular-weight polyethylene resin as its material.
